(19) United States
(12) Patent Application Publication
(10) Pub. No.: US 2005/0081088 A1
(43) Pub. Date: Apr. 14, 2005

(54) Array controller for disk array, and method for rebuilding disk array

(75) Inventors: Kazuyuki Tanaka, Tachikawa-shi (JP); Takehiko Kurashige, Ome-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/946,336

(22) Filed: Sep. 22, 2004

(30) Foreign Application Priority Data
Sep. 29, 2003 (JP) 2003-337755

(51) Int. Cl. G06F 11/00

(52) U.S. Cl. 714/5

(57) ABSTRACT

If one of the disk drives of a disk array malfunctions, the read unit of an array controller reads data from the remaining disks, so as to restore the data of the malfunctioning disk drive to the original state and provided this restored data in a new disk drive. If a media error occurs during this data read operation, an error data write unit writes media error-causing information, which causes a media error when the area of the new disk drive corresponding to the media error is read. The media error-causing information is written, for example, in the area of the new disk drive.

### CROSS-REFERENCE TO RELATED APPLICATIONS

This application is based upon and claims the benefit of priority from prior Japanese Patent Application No. 2003-337755, filed Sep. 29, 2003, the entire contents of which are incorporated herein by reference.

### BACKGROUND OF THE INVENTION

1. Field of the Invention

The present invention relates to an array controller for controlling a disk array made up of a plurality of disk drives and having redundancy. More specifically, the present. invention relates to an array controller and a disk array-rebuilding method, which are suitably used for rebuilding a disk array by replacing a malfunctioning disk drive, which is one of the disk drives of the disk array, with a new disk drive.

2. Description of the Related Art

RAID (Redundant Array of Inexpensive Disks, or Redundant Array of Independent Disks) is known as a technology for enhancing the reliability of data by use of redundancy data. In other words, RAID is a redundant disk array comprising a plurality of disk drives. With respect to the RAID, several RAID levels are defined, such as RAID1 (mirroring) and RAID5 (striping using parity). Each RAID level is known as a technology that restores data to its original state when one of the disk drives malfunctions. Therefore, data and redundancy data are arranged in the redundancy disk array without reference to the RAID level in use.

Let us consider the case where one of the disk drives constituting a redundancy disk array malfunctions. In such a case, the disk array is rebuilt in the manner disclosed, for example, in Jpn. Pat. Appln. KOKAI Publication No. 8-147112. To rebuild the disk array, the malfunctioning disk drive must be replaced with a new disk drive. Then, the array controller (i.e., the RAID controller) must start rebuild processing. In this rebuild processing, data corresponding to all areas of the malfunctioning disk drive is restored to its original state in the new disk drive. Data stored in all areas of the normally-operating disk drives is used for that data restoration. The rebuild processing restores the redundancy of the disk array. In the case of a RAID1 disk array, for example, data corresponding to all areas of the existing drives is read and written in a new disk drive. In this manner, the data in the malfunctioning disk drive is restored to its original state in the new disk drive.

When the data is read from the existing disk drives, a so-called “media error” may occur. The media error indicates a state where data cannot be normally read from a disk drive even after a read retry operation is repeated a predetermined number of times. Let us assume here that the logical block address of the disk drive undergoing the media error is LBAi. In this case, the data stored in the malfunctioning disk drive and designated by LBAi cannot be restored to its original state in the new disk drive. If the rebuild processing is continued with respect to the subsequent logical block addresses, invalid data may be stored in an apparently normal way in the area corresponding to the logical block address LBAi where the media error occurred. For example, in the case of a disk array of RAID1, the data stored in logical block address LBAi (where the media error occurred) of the existing disk drives cannot be copied to the new disk drive. If, after the end of the rebuild operation, the host issues a read command for reading data from logical block address LBAi, the invalid data will be read from the new disk drive. Therefore, if the media error occurs during the operation of reading data from the existing drives for the rebuild purpose, there is no other way but to abort the rebuild operation. In such a case, the redundancy cannot be restored to its original state with respect to not only the block of the logical block address LBAi corresponding to the media error but also the blocks of the subsequent logical block addresses.

### BRIEF SUMMARY OF THE INVENTION

An embodiment of the present invention concerns an array controller for controlling a disk array having redundancy. The disk array is made up of a plurality of disk drives. The array controller is provided with a read unit, a data restoration unit and a media error setting unit. If one of the disk drives malfunctions and the disk array is rebuilt, the read unit reads data from the remaining disks. The data restoration unit generates data corresponding to the malfunctioning disk drive on the basis of the data read by the read unit and arranges the generated data in the new disk drive used in place of the malfunctioning disk drive. If the media error occurs during the data read operation by the read unit, the media error setting unit sets information for generating a media error when the information corresponding to the area where the media error occurs is read from the new disk drive.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a computer system according to the first embodiment of the present invention.

FIG. 2A shows an example of sector data that is written in an HDD in response to an ordinary write command a host issues.

FIG. 2B shows an example of sector data that is written in the HDD in response to a write wrong command the host issues.

FIG. 3 is a flowchart illustrating operations performed when the disk array 20 of the first embodiment is rebuilt.

FIG. 4 is a flowchart illustrating operations performed in response to a read command the host 10 issues after the disk array 20 of the first embodiment is rebuilt.

FIG. 5 is a block diagram showing a computer system according to the second embodiment of the present invention.

FIG. 6 is a flowchart illustrating operations performed when the disk array 20 of the second embodiment is rebuilt.

FIG. 7 is a flowchart illustrating operations performed in response to a read command the host 10 issues after the disk array 20 of the second embodiment is rebuilt.

FIG. 8 illustrates a disk array 200 which is according to a modification of the first embodiment and which is used in place of the disk array 20 shown in FIG. 1.

FIG. 9 illustrates data restoring processing executed when the disk array 200 of the modification of the first embodiment is rebuilt.

### DETAILED DESCRIPTION OF THE INVENTION

Embodiments of the present invention will now be described with reference to the accompanying drawings.

### FIRST EMBODIMENT

FIG. 1 is a block diagram showing a computer system according to the first embodiment of the present invention. The computer system shown in FIG. 1 comprises a host (host computer) 10, a disk array 20 and an array controller (hereinafter referred to as “RAID controller”) 30. The host 10 executes various kinds of applications. The disk array 20 is used as an external storage device of the host 10.

The disk array 20 is a RAID including a plurality of hard disk drives (hereinafter referred to as “HDD”), for example two HDDs 21-0 and 21-1. For the sake of simplicity, it is assumed that the HDDs 21-0 and 21-1 have the same storage capacity. The disk array 20 of the first embodiment operates under the control of the RAID controller 30 and functions as a so-called mirroring disk array, i.e., a disk array to which RAID1 is applied. In the disk array 20 to which RAID1 is applied, the host 10 can recognize only one of the HDDs 21-0 and 21-1 of the disk array 20. The other HDD is used for retaining a copy of the data stored in the first HDD. The HDD the host 10 can recognize is referred to as a master HDD, while the HDD that retains a copy of the data stored in the master HDD is referred to as a backup HDD.

HDDs 21-0 and 21-1 support write long commands. A write long command is a command for writing the write data designated (transferred) by the host in an HDD, without any change to the write data. (The write data is, for example, one-sector data including an error correction code.) When the write long command is executed, the ECC generator of the HDD is prevented from operating. In the operating condition, the ECC generator generates error correction codes (ECC) on the basis of the write data. ECC is redundant data used for correcting errors in the data.

The RAID controller 30 controls the disk array 20. Where the disk array 20 functions as RAID1, the RAID controller 30 writes data requested by the host 10 in one of the HDDs 21-0 and 21-1 (i.e., the master HDD). Simultaneously, the RAID controller 30 writes a copy of the same data in the other HDD (i.e., the backup HDD) at a position whose relative position is the same as the master HDD.

The RAID controller 30 comprises a rebuild control unit 31 configured to rebuild the disk array 20. The rebuild control unit 31 includes a copy unit 311, an error determination unit 312 and an error data write unit 313. The copy unit 311 is actuated when the host 10 issues a command of rebuilding the disk array 20. The copy unit 311 makes a copy of the data of the normally-operating HDD (hereinafter referred to as a source HDD), which is one of the HDDS 21-0 and 21-1 of the disk array 20, and stores that copy in a new HDD (hereinafter referred to as a target HDD), which is used in place of the malfunctioning HDD. In other words, the copy unit 311 serves as a data restoration unit which restores the data of the malfunctioning HDD to the original state, using the data stored in the source HDD, and stores the restored data in the target HDD. The copy unit 311 includes a read unit 311a and a write unit 311b. The read unit 311a reads data out of the source HDD in units of one block. The write unit 311b writes the data, read out by the read unit 311a, in the target HDD in units of one block. The error determination unit 312 checks data in units of one block to determine whether a media error is present in each block. The media error is an error indicating that the read unit 311a of the copy unit 311 fails to correctly read data from the source HDD. The error data write unit 313 writes specific error data in the area (block) of the target HDD designated by logical block address LBAi. The specific error data is written using a write long command. LBAi is a logical block address at which a media error occurs in the operation of rebuilding the disk array 20. The specific error data is intended to refer to data that never fails to cause a media error.

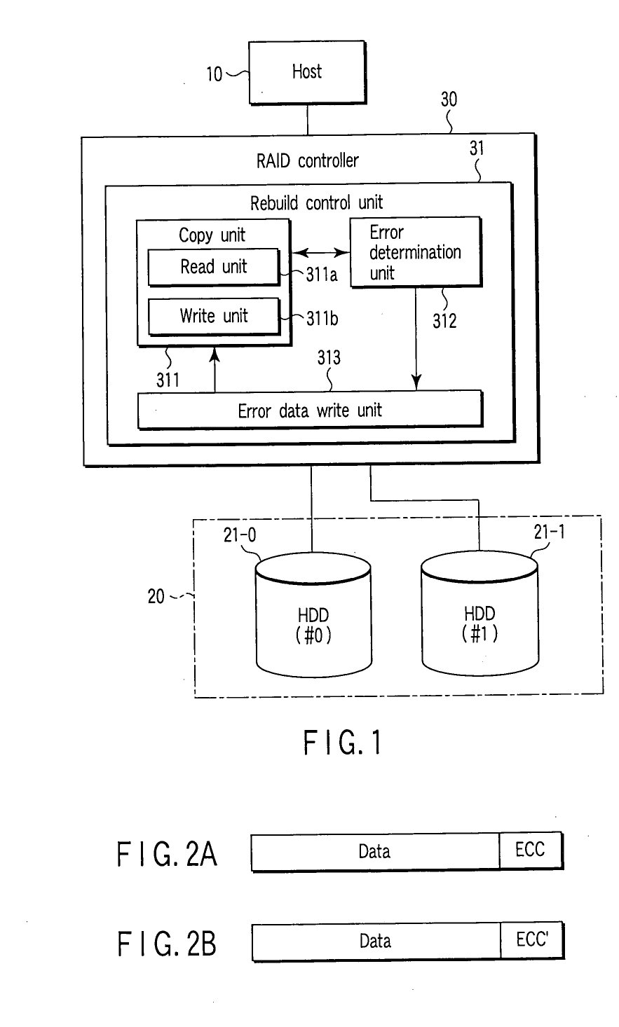

FIG. 2A shows sector data that is written in an HDD in response to an ordinary write command a host issues. Referring to FIG. 2A, the sector data written in the HDD includes data DATA transferred from the host, and an ECC attached to the data DATA. The ECC is generated by the ECC generator of the HDD on the basis of the data DATA. The data DATA and the ECC are consistent with each other. When the sector data shown in FIG. 2A is read, therefore, the error detection and error correction can be accurately performed on the basis of the data DATA and the ECC attached thereto.

FIG. 2B shows specific error data that is written in an HDD in response to a write wrong command supplied from the error data write unit 313. Referring to FIG. 2B, the sector data (error data) written in the HDD includes data DATA and ECC′. ECC′ has no direct relationship with ECC (which can be generated from data DATA). Since ECC′ and ECC have no direct relationships with each other, ECC′ is not consistent with data DATA and is therefore invalid. When the sector data including DATA and ECC′ is read, the error correction cannot be performed correctly, resulting in a media error.

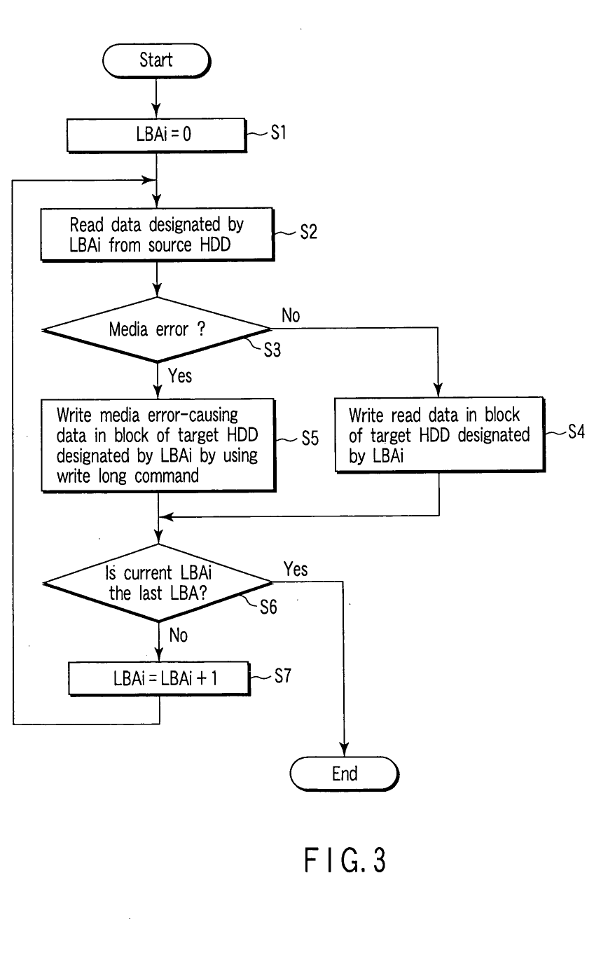

The operation of the computer system shown in FIG. 1 will now be described, referring to the flowchart shown in FIG. 3. In the description below, reference will be made to the case where the disk array 20 is rebuilt. It is assumed here that HDD 21-1, which is one of HDDs 21-0 and 21-1 of the disk array 20, malfunctions and is to be replaced with a new HDD. For the sake of simplicity, the new HDD used in place of the malfunctioning HDD 21-1 will be denoted by the same reference numeral as the original HDD 21-1. When the host 10 supplies the RAID controller 30 with a command for rebuilding the disk array 20, the rebuild control unit 31 of the RAID controller 30 is actuated. In the operation of building the disk array 20, the source HDD is the existing HDD 21-0, and the target HDD is the newly-used HDD 21-1.

When the rebuild control unit 31 is actuated, the copy unit 311 of the rebuild control unit 31 sets the logical block address LBAi at initial value 0 (Step S1). In response to this, the read unit 311a of the copy unit 311 reads the data stored in the area (block) of the source HDD 21-0 designated by LBAi (Step S2). The error determination unit 312 determines whether or not a media error has occurred (if the media error occurs, this means that the data designated by LBAi cannot be correctly read from the source HDD 21-0) (Step S3).

If the media error does not occur (i.e., if the data designated by LBAi can be correctly read from the source HDD 21-0), the error determination unit 312 informs the copy unit 311 of the “no error” i state. In response to this, the write unit 311b of the copy unit 311 writes the data which the read unit 311a has correctly read from the source HDD 21-0 in the area (block) of the target HDD 21-1 designated by LBAi (Step S4). As a result, the data in the source HDD 21-0 designated by LBAi is copied to the block of the target HDD 21-1 designated by the same LBAi. In the first embodiment wherein RAID1 is applied to the disk array 20, the data in the block of the source HDD 21-0 designated by LBAi is identical to the data in the block of the malfunctioning HDD 21-1 designated by the same LBAi. Therefore, the data of the malfunctioning HDD 21-1 can be restored to its original state in the target HDD 21-1 by copying data from the source HDD 21-0 to the target HDD 21-1.

If a media error occurs (if the data designated by LBAi cannot be read from the source HDD 21-0 despite the read retry operations repeated by a predetermined number of times), the following operation is performed. First of all, the error determination unit 312 informs the copy unit 311 and the error data write unit 312 that an error (a media error) occurred. In response, the error data write unit 313 writes specific error data (DATA+ECC′) shown in FIG. 2B in the block of the target HDD 21-1 designated by LBAi (Step S5). The specific error data is data that never fails to cause a media error, and is written by use of a write long command. In other words, the error data write unit 313 issues the write long command commanding that a data write operation be performed with respect to the block designated by LBAi, and supplies the write long command to the target HDD 21-1. Simultaneous with this, the error data write unit 313 sends the specific error data (DATA+ECC′) shown in FIG. 2B to the target HDD 21-1. Where the command the HDD 21-1 receives is a write long command, the ECC generator of the HDD 21-1 is disabled. Let us assume here that the write long command commands that a data write operation be performed for the block designated by LBAi. In this case, write data transferred from an external portion of the HDD 21-1 to the HDD 21-1 is written in the block which is on a medium of the HDD 21-1 and which is designated by LBAi. In the case of the first embodiment, the specific error data (DATA+ECC′) shown in FIG. 2B is supplied to the HDD 21-1 by the error data write unit 313. In step S5 described above, therefore, the specific error data (DATA+ECC′) is written in the block of the HDD 21-1 designated by LBAi, in accordance with the write long command. Since the specific error data (DATA+ECC′) is written in the block designated by LBAi (Step S5), a media error never fails to occur when the block is read. When step S5 is executed, the copy unit 311 does not perform Step S4 (i.e., the data read from the source HDD 21-0 is not written in the target HDD 21-1).

As described above, the first embodiment executes a write long command if a media error occurs in the source HDD 21-0 in the process of copying data from the source HDD 21-0 to the target HDD 21-1 so as to rebuild the disk array 20. Because the write long command is executed, the specific error data is written in the block of the target HDD 21-1 at the same relative position as the logical block address LBAi where the media error occurs. When the block of the HDD 21-1 designated by LBAi is read thereafter,.a media error occurs as in the case where the block of HDD 21-0 designated by LBAi is read. Thus, invalid data is prevented from being processed in an ordinary way.

After execution of Steps S4 and 5, the copy unit 311 determines whether current LBAi is the last LBA of HDD 21-0 or 21-1 (Step S6). If current LBAi is not the last LBA, the copy unit 311 increments the current LBAi by “1” so as to designate the logical block addresses of the next copy source and the next copy destination (Step S7). The flow returns to Step S2, in which the copy unit 311 copies data from the source HDD 21-0 to the target HDD 21-1 in accordance with the incremented LBAi. If, on the other hand, current LBAi is the last LBA, the copy unit 311 ends the operation of copying data from the source HDD 21-0 to the target HDD 21-1 (i.e., the operation of rebuilding the disk array 20).

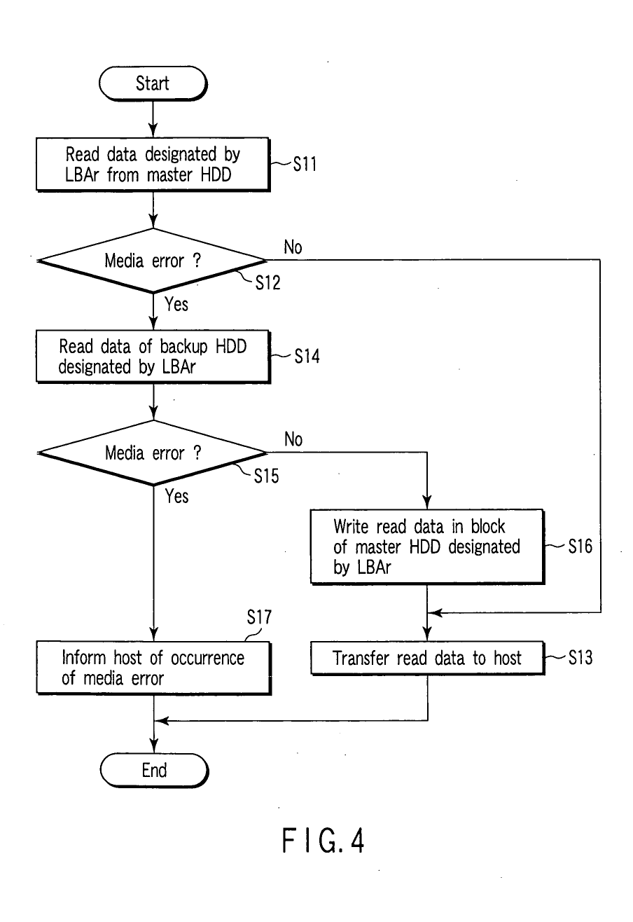

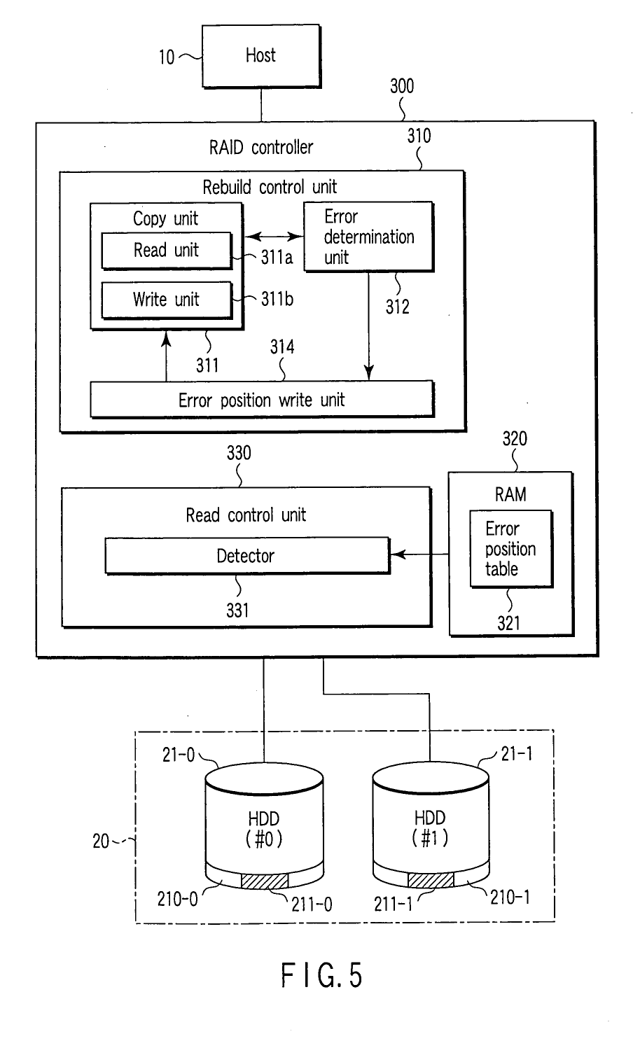

Referring to the flowchart shown in FIG. 4, a description will be given of the operations performed in response to a read command the host 10 issues after the disk array 20 is rebuilt. In the descriptions below, reference will be made to the case where HDD 21-0 is used as a master HDD, and HDD 21-1, to which the data of HDD 21-0 is copied in the operation of rebuilding the disk array 20, is used as a backup HDD. It is assumed here that the read command the host 10 issues and supplies to the RAID controller 30 commands reading data from the block designated by logical block address LBAr.

In this case, the RAID controller 30 reads the data designated by LBAr from the master HDD 21-0 in accordance with the read command issued by the host 10 (Step S11). Then, the RAID controller 30 determines whether a media error occurs or not (Step S12). If a media error does not occur during the data read operation in Step S11, the RAID controller 30 determines that the data designated by LBAr has been correctly read from the master HDD 21-0. In this case, the RAID controller 30 transfers the read data to the host 10 (Step S13).

If it is determined in Step S12 that a media error occurs in the data read operation of Step S11, then the RAID controller 30 reads the data of the backup HDD 21-1 designated by LBAr (Step S14). Then, the RAID controller 30 determines whether a media error occurs or not (Step S15). If no media error occurs in the data read operation of Step S14, the RAID controller 30 determines that the data designated by the read command from the host 10 has been correctly read from the backup HDD 21-1. Based on this determination, the RAID controller 30 writes the read data (which has been correctly read) in the block of the master HDD 21-0 designated by LBAr (Step S16). As a result, the block of the master HDD 21-0, in which the media error occurs during the data read operation of Step S11, is restored to its original state. The RAID controller 30 transfers the read data (which is used for this data restoration) to the host 10 (Step S13). In order to confirm the restoration of the block of the master HDD 21-0 where the media error occurred, the data is read from the block once again to see whether the media error occurs.

If the media error occurs in the data read operation in Step S14 (Step S15), the RAID controller 30 determines that the data designated by the read command from the host 10 cannot be correctly read even after a read retry is repeated with respect to HDDs 21-0 and 21-1. In this case, the RAID controller 30 informs the host 10 of the occurrence of the media error (Step S17). In this case, it is assumed that the logical block address LBAr designated by the read command from the host 10 is the same as the logical block address LBAi used for designating the block of the HDD 21-1 in which the specific error data shown in FIG. 2B is written. If this is the case, the occurrence of the media error is detected in both steps S12 and S15. Therefore, the invalid data is prevented from being processed in a normal way.

### SECOND EMBODIMENT

FIG. 5 is a block diagram showing a computer system according to the second embodiment of the present invention. In FIG. 5, the same reference numerals as used in FIG. 1 denote structural elements corresponding to those shown in FIG. 1. The computer system shown in FIG. 5 comprises a host 10, a RAID controller 300 and a disk array 20. RAID controller 300 corresponds RAID controller 30 shown in FIG. 1. Areas 210-0 and 210-1, which are parts of HDDs 21-0 and 21-1 constituting the disk array 20, are reserved beforehand as dedicated reserve areas which the RAID controller 300 can use. Areas 210-0 and 210-1 (which will be hereinafter referred to as reserve areas) are those areas of HDDs 21-0 and 21-1 which are the same in relative positions. Areas 211-0 and 211-1, which are portions of reserve areas 210-0 and 210-1, are used for storing logical block addresses LBAi (error position information) indicating the positions (blocks) where a media error occurs during the operation of rebuilding the disk array 20. LBAi is stored in these areas 211-0 and 211-1 (hereinafter referred to as error position storage areas) by using an LBAi list or a bit map table. The bit map table is made of bits corresponding to all LBAs of HDDs 21-0 and 21-1. When a media error occurs in the operation of rebuilding the disk array 20, the bit corresponding to the location of the media error is set, for example, in the “ON” state. This processing is equivalent to the operation of writing LBAi in the error position storage areas 211-0 and 211-1.

The RAID controller 30 comprises a rebuilt control unit 310, a RAM 320 and a read control unit 330. Rebuilt control unit 310 correspond to the rebuilt control unit 31 shown in FIG. 1. Rebuilt control unit 310 includes an error position write unit 314. The error position write unit 310 is used in place of the error data write unit 313 of the rebuild control unit 31 shown in FIG. 1. When a media error occurs in the process of rebuilding the disk array 20, the error position write unit 314 writes logical block address LBAi in the error position storage areas 211-0 and 211-1 of HDD 21-0 and HDD 21-1.

Part of the storage areas of RAM 320 is used for storing an error position table 321, which retains a copy of the error position storage area 211-0 or 211-1. The read control unit 330 reads data from the disk array 20 in accordance with the read command issued by the host 10. The read control unit 330 include a detector 331. The detector 331 detects whether or not the logical block address LBAr designated by the read command from the host 10 is stored in the error position storage areas 211-0 and 211-1 as positional information indicating the position (block position) of the media error. The detector 331 performs this detection by referring to the error position table 321.

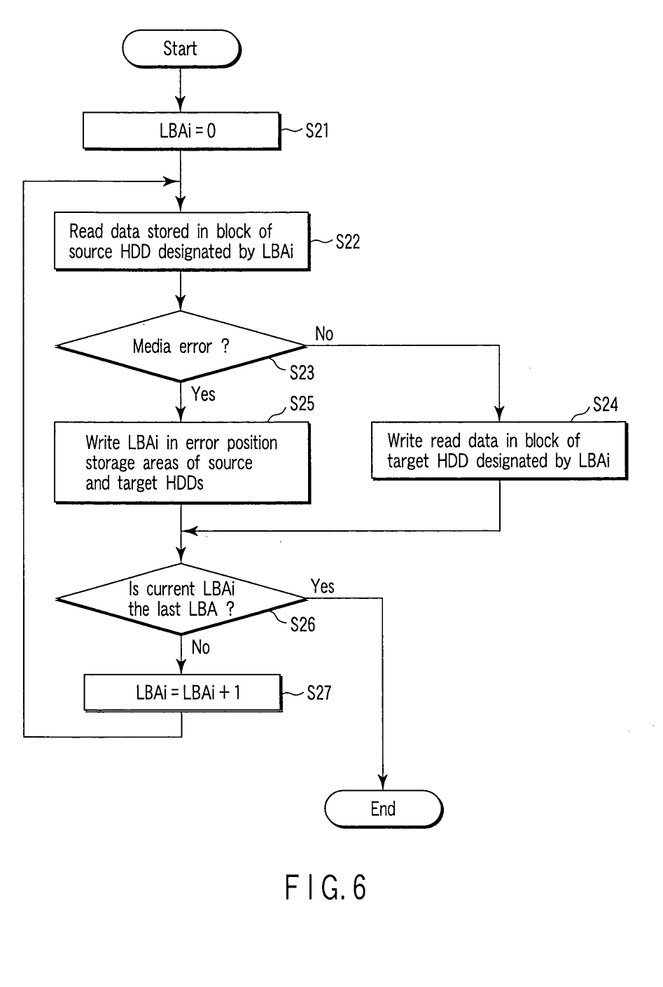

Referring to the flowchart shown in FIG. 6, a description will be given of the operation of the computer system shown in FIG. 5. In the descriptions below, reference will be made to the case where HDD 21-0 is used as a source HDD, and HDD 21-1 is used as a target HDD, as in the case of the first embodiment. First of all, the copy unit 311 of the rebuild control unit 31 sets the logical block address LBAi at initial value 0 (Step S21). In response to this, the read unit 311a of the copy unit 311 reads the data stored in the block of the source HDD 21-0 designated by LBAi (Step S22). The error determination unit 312 determines whether or not a media error has occurred (if the media error occurs, this means that the data designated by LBAi cannot be correctly read from the source HDD 21-0) (Step S23). If the media error does not occur (i.e., if the data designated by LBAi can be correctly read from the source HDD 21-0), the error determination unit 312 informs the copy unit 311 of the “no error” state. In response to this, the write unit 311b of the copy unit 311 writes the data which the read unit 311a has correctly read from the source HDD 21-0 in the block of the target HDD 21-1 designated by LBAi (Step S24).

If a media error occurs, the error determination unit 312 informs the copy unit 311 and the error data write-unit 312 that an error occurred. In response, the error position write unit 314 writes LBAi indicating the position (block) where the media error occurred. LBAi is written in the error position storage area 211-0 of the source HDD 21-0 and the error position storage area 211-1 of the target HDD 21-1 (Step S25). When this step S25 is executed, the copy unit 311 does not perform Step S24 (i.e., the data read from the source HDD 21-0 is not written in the target HDD 21-1).

As described above, the second embodiment writes block address LBAi corresponding to the position of a media error in both the error position storage areas 211-0 and 211-0, if the media error occurs in the source HDD 21-0 in the process of copying data from the source HDD 21-0 to the target HDD 21-1 so as to rebuild the disk array 20. Because block address LBAi is written in both the error position storage areas 211-0 and 211-1, the detector 331 refers to error position storage area 211-0, error position storage area 211-1 or error position table 321, so as to detect that data is read from the position (block) where a media error occurs. In this case, the read control unit 330 informs the host 10 of the occurrence of the media error, without having to read the block of the HDD 21-1 designated by LBAi. As a result, invalid data is prevented from being processed in an ordinary way. The second embodiment differs from the first embodiment in that HDDs 21-0 and 21-1 do not have to support a write long command. In the second embodiment, error position table 321 is referred to, as will be described later.

After execution of Steps S24 and S25, the copy unit 311 determines whether current LBAi is the last LBA of HDD 21-0 or 21-1 (Step S26). If current LBAi is not the last LBA, the copy unit 311 increments the current LBAi by “1” (Step S27). Then, the flow returns to Step S22. If current LBAi is the last LBA, the copy unit 311 ends the operation of copying data from the source HDD 21-0 to the target HDD 21-1 (i.e., the operation of rebuilding the disk array 20).

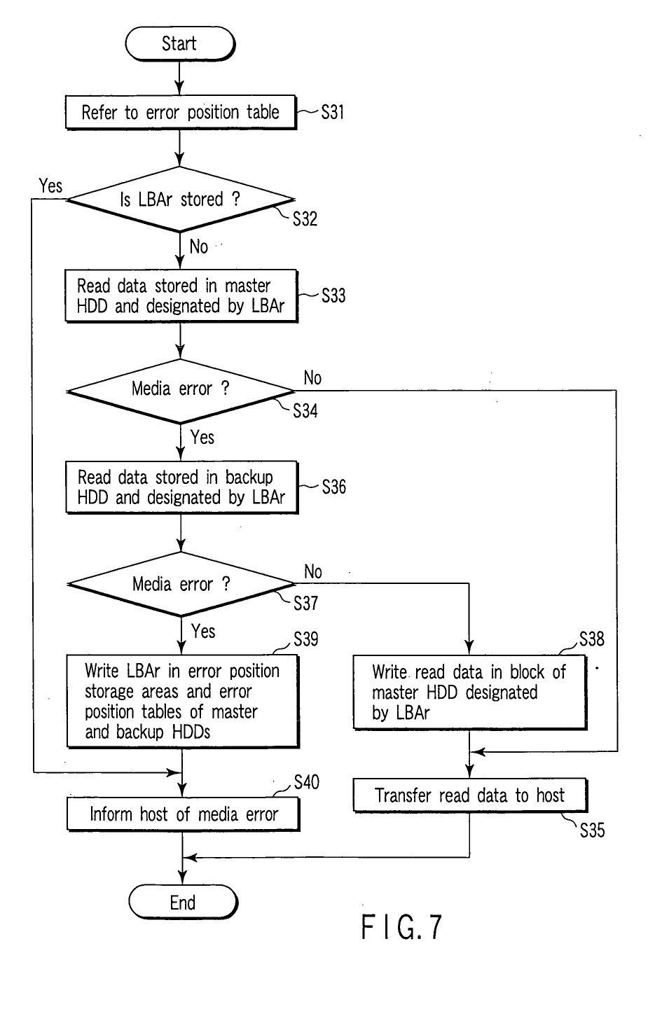

Referring to the flowchart shown in FIG. 7, a description will be given of the operations performed in response to a read command the host 10 supplies to the disk array 20 after the disk array 20 is rebuilt. In the descriptions below, reference will be made to the case where HDD 21-0 is used as a master HDD, and HDD 21-1, to which the data of HDD 21-0 is copied in the operation of rebuilding the disk array 20, is used as a backup HDD. It is assumed that when the computer system shown in FIG. 5 is started, the error position table 321, which includes either a copy of the error position storage area 211-0 of HDD 21-0 or a copy of the error position storage area 211-1 of HDD 21-1, is stored in the RAM 320. The table 321 need not necessarily be a copy of the error position storage area 211-0 or 211-1. For example, when the error position storage areas 211-0 and 211-1 store an LBAi list indicating that a media error occurs in HDD 21-0, table 321 may store a bit map table prepared from the LBAi list and showing LBAi that indicates the positions of the media error. Where the RAID controller 300 can be provided with a nonvolatile memory, step S25 described above may be replaced with a step of writing LBAi indicating the position of the media error in the nonvolatile memory.

Let us assume that a read command is supplied from the host 10 to the RAID controller 300 and the read command includes a logical block address LBAr for designating the logical block to be read. When the host 10 issues the read command, the detector 331 of the read control unit 330 of the RAID controller 300 refers to the error position table 321 of the RAM 320 (Step S31). The detector 331 refers to the table 321, by using the logical block address LBAr designated by the read command from the host 10 as a key. The detector 331 determines whether the logical block address LBAr is stored in the table 321 as information indicating the position of a media error (Step S32). The reason for referring to the table 321 is to increase the processing speed, and the operation of referring to the table 321 is equivalent to the operation of referring to the error position storage area 211-0 or 211-1.

If LBAr is not stored in the table 321 as information indicating the position of the media error, the read control unit 330 reads the data stored in the master HDD 21-0 and designated by LBAr (Step S33). Then, the read control unit 330 determines whether the media error occurs or not (Step S34). If the media error does not occur in the data read operation of Step S33, the read control unit 330 determines that the data designated by the read command from the host 10 has been read correctly from the master HDD 21-0. In this case, the read control unit 330 transfers the read data to the host 10 (Step S35).

If the media error occurs in the data read operation of Step S33 (Step S34), the read control unit 330 reads the data stored in the backup HDD 21-1 and designated by LBAr (Step S36). Then, the read control unit 330 determines whether the media error occurs or not (Step S36). If no media error occurs in the data read operation of Step S36, the read control unit 330 determines that the data designated by the read command from the host 10 has been read correctly from the backup HDD 21-1. In this case, the RAID controller 30 writes the read data in the block of the master HDD 21-0 designated by LBAr (Step S38). The read control unit 330 transfers the read data to the host 10 (Step S35).

If the media error occurs in the data read operation of Step S36 (Step S37), the read control unit 330 advances to step S39. In Step S39, the read control unit 330 writes LBAr in the error position storage area 211-0 of the master HDD 21-0, the error position storage area 211-1 of the backup HDD 21-1 and the error position table 321 of the RAM 320 (Step S39). When a read command for reading the data in the HDD designated by LBAr is subsequently issued, Step S32 determines that LBAr is stored in table 321 as information indicating the position of a media error. As will be described later, the read control unit 330 can inform the host 10 of the media error, with no need to read data from HDDs 21-0 and 21-1. After executing Step S39, the read control unit 330 informs the host 10 of the media error (Step S40).

Let us assume that the determination in Step S32 shows that table 321 stores LBAr designated by the read command from the host 10 as information indicating the position of the media error. Where LBAr is stored in table 321, this means that LBAr is stored in the error position storage areas 211-0 and 211-1 as well. The read control unit 330 determines that the read command is commanding an operation of reading data from the position (block) of a media error. Therefore, the read control unit 330 immediately informs the host 10 of the media error without reading data from HDDs 21-0 and 21-1 (Step S40)

Modification

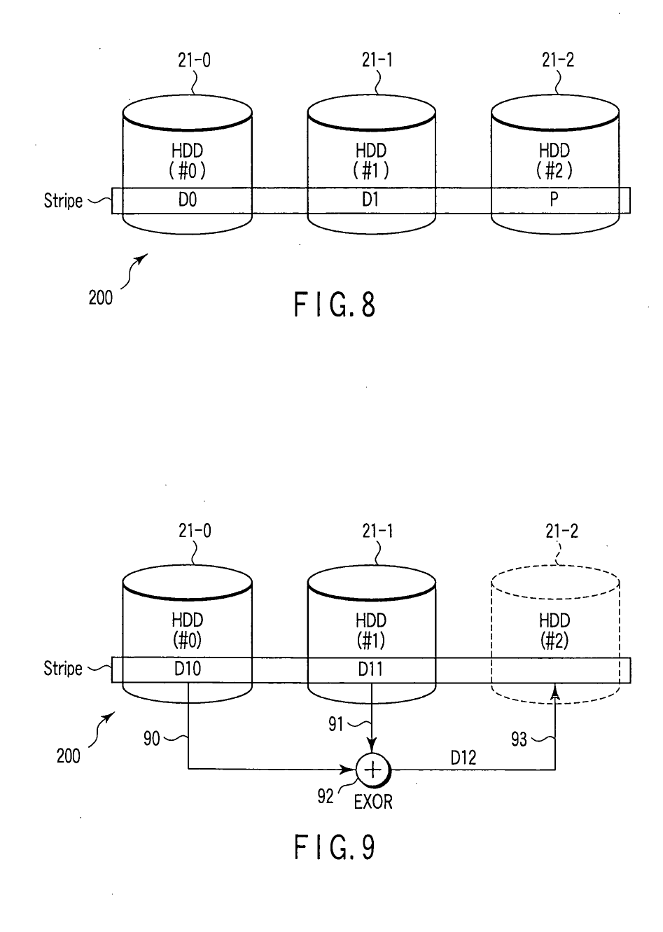

In the first embodiment the disk array 20 is made up of two HDDs 21-0 and 21-1, and functions as a disk array based on RAID1 (i.e., a mirroring disk array). Needless to say, the number of HDDs constituting the disk array may be three or more, and the RAID level is not limited to RAID1. A description will therefore be given of a modification of the first embodiment, wherein the disk array 200 shown in FIG. 8 is employed in place of the disk array 20 shown in FIG. 1. The descriptions below will be given with reference to FIG. 1.

The disk array 200 shown in FIG. 8 is made up of three HDDs 21-0, 21-1 and 21-2. It is assumed here that the disk array 200 is of RAID5 level. HDDs 21-0, 21-1 and 21-2 are used for storing data and parity data (redundant data). Parity data is stored in HDDs 21-0 to 21-2 in a distributed fashion. Where the disk array 200 is used as an array of RAID3 level, two of the HDDs 21-0 to 21-2 are used for storing data (they are used as data disks), and the remaining one is used for storing parity data (it is used as a parity disk).

The disk areas of the disk array 200 made up of HDDs 21-0 to 21-2 are divided into stripes for management, as shown in FIG. 8. The stripes are block areas of HDDs 21-0 to 21-2 that are identical in light of their relative positions. For the sake of simplicity, one stripe is defined by one block of each of the HDDs 21-0 to 21-2. In other words, one stripe is defined by three blocks. The blocks of two of the HDDs 21-0 to 21-2 store data D0 and data D1. The block of the remaining HDD stores parity data P corresponding to data D0 and data D1. If one of the HDDs 21-0 to 21-2 of the disk array 200 malfunctions, the data of the remaining two HDDs is used for restoring the data or parity data of the malfunctioning HDD to their original state in units of one stripe. In some cases, the blocks (a group of blocks) which are part of the HDDs 21-0 to 21-2 and which are identical in relative position are referred to as a stripe, and a plurality of such stripes are referred to as a stripe group.

FIG. 9 illustrates data restoring processing executed when the disk array 200 shown in FIG. 8 is rebuilt. The processing illustrated in FIG. 9 is executed, for example, in the case where HDD21-2 of the disk array 200 malfunctions and is replaced with a new HDD21-2 (to which the same reference numeral as the malfunctioning HDD is assigned for the sake of simplicity). In this case, the data restoring processing (which restores the data in the malfunctioning HDD21-2 to the original state on the basis of the data stored in the HDDs 21-0 and 21-1, and which writes the restored data in the new HDD21-2) is executed as below.

First of all, the RAID controller 30 (FIG. 1) performs data read operations 90 and 91 so as to read data D10 and data D11 from those blocks of HDDs 21-0 and 21-1 designated by LBAi. If no media error occurs in the data read operations 90 and 91, data D10 and data D11, which are read from HDDs 21-0 and 21-1, are subject to the exclusive OR (EXOR) operation 92. Data D12 obtained by this EXOR operation is written in the block of HDD21-2 of the corresponding stripe. If both D10 and D11 are non-parity data, this indicates that D12 is parity data. If one of D10 and D11 is parity data, D12 is non-parity data. In the example illustrated in FIG. 9, the operations described above are repeated, with the value of LBAi incremented.

In the case where the disk array 200 of RAID5 level is rebuilt, the data which is restored in units of one stripe on the basis of the data stored in HDDs 21-0 and 21-1 is written in the newly employed HDD21-2. If a media error occurs in HDD 21-0 or 21-1 in the process of reading data from HDDs 21-0 and 21-1 for the data restoration in units of one stripe, the specific error data shown in FIG. 2B is written in the corresponding blocks of the newly-employed HDD21-2 by use of a write long command, as in the case of the first embodiment described above.

Let us assume that after the disk array 200 is rebuilt, the block of HDD21-2 in which the specific error data is written, or the corresponding block of another HDD is read in response to a read command from the host 10. If a media error occurs when the block designated by the read command is read, the data of that block is restored to its original state by reading data from the corresponding blocks of the other two HDDs. If a media error occurs in at least one of the two HDDs then, the data of the block designated by the read command cannot be restored. As can be seen from this, the data restoration is not possible if the specific error data is written in the block of the HDD designated by the read command or the corresponding block of another HDD. In this case, the RAID controller 30 informs the host 10 of the media error, as in Step S17 of the first embodiment.

As in the second embodiment, an error position storage area may be provided in each of the HDDs 21-0 to 21-2. In this case, LBAi indicating where a media error occurs in the process of rebuilding the disk array 200 is written in the error position storage areas. This modification can be adopted when the disk array 200 is of RAID3 level or of RAID4 level.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An array controller for controlling a disk array having redundancy, the disk array including a plurality of disk drives, the array controller comprising:
a read unit being responsive to a case where one of the disk drives malfunctions and the disk array is rebuilt, and configured to read data from remaining disks;
a data restoration unit configured to generate data corresponding to the malfunctioning disk drive based on data read by the read unit and to arrange the generated data in a new disk drive used in place of the malfunctioning disk drive; and
a media error setting unit being responsive to a case where a media error occurs during a data read operation by the read unit, and configured to set information for generating a media error when information corresponding to the area where the media occurs is read from the new disk drive.

2. An array controller according to claim 1, wherein the media error setting unit includes an error data write unit configured to write specific error data for forcibly generating a media error, in the new disk drive at an area corresponding to the area where the media error occurs.

3. An array controller according to claim 2, wherein:
the disk drives support a write long command; and
the error data write unit writes the specific error data, using the write long command, in the new disk drive at the area corresponding to the area where the media error occurs.

4. An array controller according to claim 2, further comprising:
a read control unit configured to control a data read operation in accordance with a read command supplied from a host that uses the disk array, the data read operation being an operation of reading data designated by the read command from the disk array; and
an error notification unit configured to notify the host of a media error when this media error occurs in the data read operation controlled by the read control unit.

5. An array controller according to claim 4, wherein:
the read control unit performs the data read operation for at least one of the disk drives in response to the read command supplied from the host, and, if a media error occurs, reads data from remaining ones of the disk drives such that data designated by the read command is acquired by utilization of the redundancy of the disk array; and
the error notification unit notifies the host of the media error if the media error occurs when the read control unit performs the data read operation so as to acquire the data designated by the read command by utilization of the redundancy of the disk array.

6. An array controller according to claim 1, wherein the media error setting unit includes an error position write unit configured to write address information specifying an area where the media error occurs, in a nonvolatile storage area.

7. An array controller according to claim 6, further comprising:
a detector responsive to a read command which is issued by a host that uses the disk array and which includes address information designating an area to be read, and configured to detect whether the address information included in the command is stored in the nonvolatile storage area; and
an error notification unit configured to notify the host of a media error when the detector detects that the address information included in the read command is stored in the nonvolatile storage area.

8. An array controller according to claim 7, further comprising:
a read control unit configured to control a data read operation in accordance with a read command supplied from the host, the data read operation being an operation of reading data designated by the read command from the disk array,
wherein:
the detector operates before the read control unit performs the data read operation; and
the read control unit operates when the detector does not detect that the address information included in the read command is stored in the nonvolatile storage area.

9. A method which is applied to an array controller for controlling a redundancy-provided disk array including a plurality of disk drives, and which rebuilds the disk array, the method comprising:
in response to a case where one of the disk drives malfunctions and the disk array is rebuilt, reading data from remaining disks in units of a predetermined amount;
in response to a case where the data is normally read from the remaining disks, generating data corresponding to the malfunctioning disk drive based on normally read data and arranging the generated data in a new disk drive used in place of the malfunctioning disk drive; and
in response to a case where a media error occurs. during a data read operation from the remaining disks, setting information for generating a media error when information corresponding to the area where the media occurs is read from the new disk drive.

10. A method according to claim 9, wherein the setting includes writing specific error data for forcibly generating a media error, in the new disk drive at an area corresponding to the area where the media error occurs.

11. A method according to claim 9, wherein the setting includes writing address information specifying an area where the media error occurs, in a nonvolatile storage area.
